(19) United States
(12) Patent Application Publication
(10) Pub. No.: US 2005/0232251 A1
(43) Pub. Date: Oct. 20, 2005

(54) Personal communication device having multiple user IDs

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/824,039

(22) Filed: Apr. 14, 2004

(51) Int. Cl. H04L 12/66

(52) U.S. Cl. 370/356

(57) ABSTRACT

The present invention provides a personal communication device capable of supporting multiple packet communication clients, which are associated with unique IDs for facilitating packet communications. Accordingly, packet communications initiated from or intended for a personal communication device may be established using either of the communication IDs. The personal communication device may provide a common user interface for each of the multiple packet communication clients. Any communication-related information, such as call logs, messages, contact information, and directory information, may be combined or separated in association with the corresponding communication client. The common user interface will provide ready access to and use of the information in combined or separated forms. The multiple communication clients may register with the same or different service nodes, which will facilitate the establishment of sessions involving the personal communication device.

### FIELD OF THE INVENTION

The present invention relates to communications, and in particular to providing a personal communication device capable of supporting multiple user IDs.

### BACKGROUND OF THE INVENTION

Traditional telephone communications associate a telephony address, which is generally a directory number, with a particular device or location. Notably, the telephony addresses are not necessarily associated with a particular user in many situations, including in business applications and especially in residential applications where everyone in a family is associated with one directory number. As personal communications evolve, traditional circuit-switched calls and media sessions over packet networks are directed toward a particular user, instead of to a particular telephone device. Directing telephony calls or sessions to a particular user is especially beneficial in packet-based telephony situations where different devices may be associated with different addresses at any given time. The portability and addressing provides significant flexibility to users and makes these users easier to reach.

In cellular telephone environments, the directory number associated with a particular telephone is generally user-specific, because most users do not share their cellular telephones. The close association with a particular user and the inherent mobility have made the use of cellular telephones extremely popular and pervasive. However, most users have multiple roles in their daily activities. For example, most users have a work role and a personal role, and prefer to have different telephony numbers or addresses for the different roles in order to keep work and personal communications separated. Although users desire different telephony addresses or numbers for the various roles, most people prefer to carry only one communication device, which at this time tends to be a cellular telephone. Certain cellular telephones will support multiple cellular directory numbers, such that the first directory number may be associated with a work role and a second directory number may be associated with a personal role.

As communication technology progresses, telephony communications will be supported over packet-based networks, which will also facilitate wireless connectivity in a fashion analogous to today's cellular networks. In these packet-based communication environments, personal communication devices are not able to readily support multiple roles on the same communication device. As such, there is a need to support multiple roles on a packet-based communication device. There is a further need to support these communications through a unified user interface on the personal communication device and allow users to separate or integrate information bearing on calls or sessions for the different roles. Given the movement toward dual-mode terminals capable of communicating using traditional cellular techniques as well as newer, local wireless techniques such as local wireless area network and Bluetooth technologies, there is a need to support multiple roles across different communication technologies.

### SUMMARY OF THE INVENTION

The present invention provides a personal communication device capable of supporting multiple packet communication clients, which are associated with unique IDs for facilitating packet communications. Accordingly, packet communications initiated from or intended for a personal communication device may be established using either of the communication IDs. The personal communication device may provide a common user interface for each of the multiple packet communication clients. Any communication-related information, such as call logs, messages, contact information, and directory information, may be combined or separated in association with the corresponding communication client. The common user interface will provide ready access to and use of the information in combined or separated forms. The multiple communication clients may register with the same or different service nodes, which will facilitate the establishment of sessions involving the personal communication device.

The personal communication device may facilitate wired or wireless packet-based communications for the various communication clients. In an alternative embodiment, the personal communication device also includes a cellular communication client and interface in addition to the multiple packet communication clients. The cellular client is treated like the other packet communication clients, such that the communication-related information may be managed as desired by the user. The cellular communication client or clients will be associated with a directory number. In yet another embodiment, a second communication interface is provided to facilitate more traditional Public Switched Telephone Network communication. Thus, the present invention supports multiple communication clients, including multiple packet communication clients, each of which has a unique communication ID, such as an address or directory number, and can support communications using any of these clients as well as manage communication-related information for each of these clients.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 illustrates registration for multiple user IDs for the embodiment illustrated in FIG. 1.

FIG. 3 illustrates supporting multiple calls or sessions according to the communication environment of FIG. 1.

FIG. 4 is a block representation of a communication environment wherein a personal communication device can support multiple user IDs over multiple communication technologies.

FIG. 5 is a block representation of a personal communication device according to a first embodiment of the present invention.

FIG. 6 is a block representation of a personal communication device according to a second embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

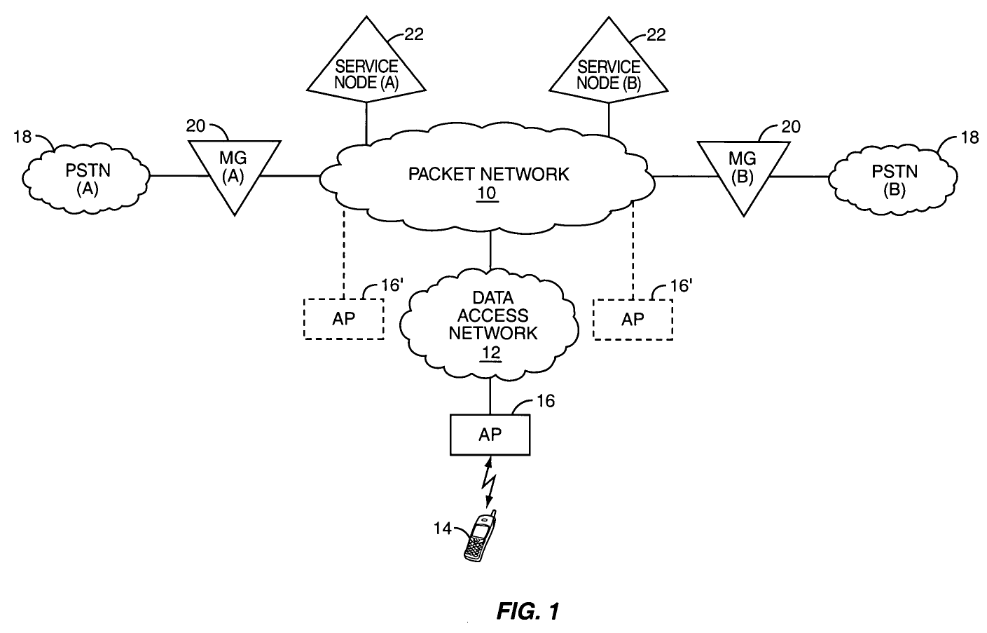

The present invention allows a personal communication device (PCD) to support multiple packet-based communication identifications (IDs). Accordingly, communications using any of the packet-based communication IDs associated with the PCD can be established with the PCD. Communication-related information, such as call logs, messages, contact information, and directory information associated with any of the multiple packet-based communication IDs may be stored in a separate or integrated fashion, as desired by the user. When the PCD is also capable of communicating using cellular techniques, the PCD may have one or more cellular-based IDs, which may be managed in cooperation with the packet-based communication IDs used for packet-based communications. Prior to delving into the details of the present invention, an overview of an exemplary communication environment in which the present invention may be practiced is provided with reference to FIG. 1.

The communication environment is centered about a packet network 10 through which packet-based communications are facilitated. These packet-based communications are generally referred to as media sessions, in which audio, video, and voice sessions may be established between any number of endpoints. Generally, the endpoints are provided access to the packet network 10 over a local data access network 12. As illustrated, an exemplary endpoint is a PCD 14, which is capable of accessing the data access network 12 through an appropriate access point (AP) 16. Although illustrated as a mobile device, the PCD 14 may take various forms, and need not be readily mobile. Further, the access technology used by the access point 16 to communicate with the PCD 14 may be wired or wireless. As such, the access point 16 may facilitate standard Ethernet connectivity, as well as wireless connectivity using wireless local area network (WLAN) techniques such as those outlined in the IEEE's 802.11 communication standards, as well as the Bluetooth standard. Sessions with the PCD 14 may extend to any device associated with the packet network 10 or a Public Switched Telephone Network (PSTN) 18, which is defined to include or provide access to associated cellular networks (not shown). Interaction between the packet network 10 and the PSTN 18 is facilitated with an interworking media gateway (MG) 20, which will provide the requisite interfaces to the packet network 10 and the PSTN 18, as well as the necessary processing to convert packet sessions to circuit-switched connections, and vice versa.

To assist in establishing sessions between the PCD 14 and another communication device directly or via the media gateways 20, service nodes 22 may be provided to assist with signaling associated with establishing sessions between the PCD 14 and the appropriate media gateway 20 or communication device on the packet network 10. For sessions involving connections over the PSTN 18, the service node 22 will cooperate with the media gateway 20 to facilitate the connection. The service node 22 may also play a role in selectively routing calls to one or several of the communication IDs of the user based on established profiles. Details regarding such operation are provided in commonly assigned U.S. application Ser. Nos. 10/382,247 filed Mar. 5, 2003 entitled COMMON CALL ROUTING FOR MULTIPLE TELEPHONY DEVICES; Ser. No. 10/384,047 filed Mar. 7, 2003 entitled USER CONTROLLED CALL ROUTING FOR MULTIPLE TELEPHONY DEVICES; and Ser. No. 10/443,369 filed May 22, 2003 entitled ADAPTIVE CALL ROUTING FOR MULTIPLE TELEPHONY TERMINALS, the disclosures of which are incorporated herein by reference in their entireties. For packet-based communications, the PCD 14 will register with one or more of the service nodes 22 and interact with the service nodes 22 when receiving and establishing sessions. In addition, the PCD 14 may connect with the packet network 10 via any number of access points 16′ located in different physical locations, allowing the PCD 14 to access the packet network 10 and communicate with the service nodes 22.

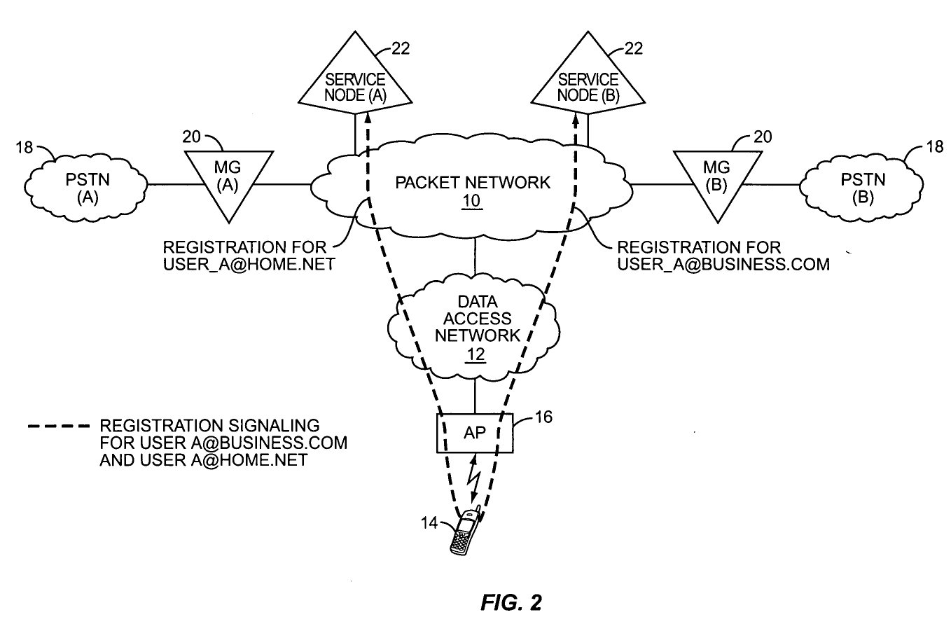

Turning now to FIG. 2, assume that the PCD 14 is capable of supporting multiple packet-based communication IDs, and as illustrated, two packet-based communication IDs: USER_A@HOME.NET and USER_A@BUSINESS.COM. These packet-based communication IDs represent home and business IDs, respectively, for a User A who is associated with the PCD 14. In one embodiment, the PCD 14 has a common control system, which supports the multiple packet-based communication IDs. In operation, each packet-based communication ID must be registered with a service node 22 in association with the PCD 14. As illustrated, different personal communication IDs for a given PCD 14 may be registered with different service nodes 22. In this example, the packet communication ID USER_A@HOME.NET is registered with service node 22(A) and the packet-based communication IDS USER_A@BUSINESS.COM is registered with service node 22(B). Once registered, session requests from remote communication devices intended for the PCD 14 will be routed to the corresponding service node 22, which will function to assist in the establishment of a session with the PCD 14 using the packet communication ID.

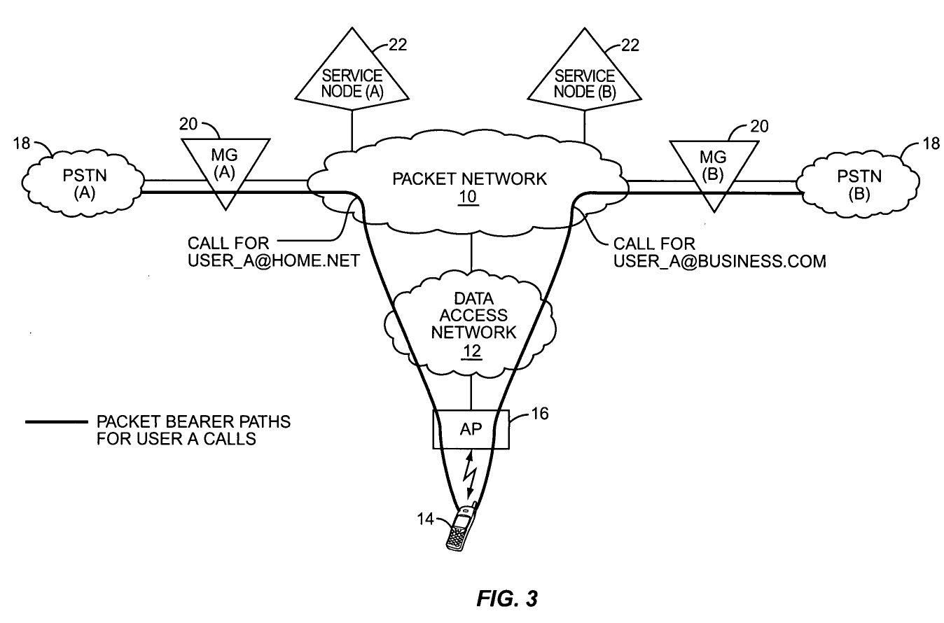

Turning now to FIG. 3, the bearer paths for different calls involving the PCD 14 are illustrated. Notably, one call involves the personal communication ID USER_A@HOME.NET and has a bearer path extending from the PCD 14 through the access point 16, data access network 12, packet network 10, media gateway 20(A), and into the PSTN 18(A). Similarly, a call involving packet communication ID USER_A@BUSINESS.COM is established with the PCD 14 through the access point 16, data access network 12, packet network 10, media gateway 20(B), and into PSTN 18(B). For the illustrated voice-based calls, packet sessions are established between the PCD 14 and the corresponding media gateways 20(A and B). Circuit-switched connections are established between the media gateways 20(A and B) and the appropriate circuit-switched endpoint in the PSTN 18(A and B, respectively).

As noted, the PCD 14 will have unique communication clients associated with each personal communication ID. Each of the communication clients may be implemented in or associated with a common control system, which supports a common user interface for the user, wherein the single PCD 14 effectively operates as multiple PCDs 14 with different personal communication IDs. The control system is preferably configured to process all of the normal communication associated information of a traditional PCD 14 for each packet communication ID. This information may include call logs, messages, contact information, and directory information. Depending on the specific configuration of the PCD 14, as well as the desires of the user, the associated communication information may be maintained in a common database or in separate databases. Further, certain information may be maintained in a common database while other information may be maintained in a database specific to the packet communication ID. For example, messages may be stored in association with the corresponding packet communication ID, wherein a common contact list may be maintained. Alternatively, there may be a personal contact list, a home contact list, and perhaps a common contact list. Further, messages may be stored separately or together, depending on how the user feels the information is most efficiently stored. For packet-based communications, the multiple packet communication clients may use a common network interface and communication technology. In other embodiments, unique network interfaces may be associated with each communication client. Regardless, each communication client is associated with a unique communication ID, which is supported by the PCD 14.

Each packet communication ID supported by the PCD 14 can be used to initiate or terminate communication sessions. A user may prefer one of the communication IDs at any given time, depending on her current needs. As an example, the user may not want to receive work related calls (involving the user's work communication ID) after 6:00 PM but may want to receive personal calls. During work hours, the user may want to receive the work related calls but only receive certain personal calls. Similarly, when initiating sessions, the user may want to select one of the available communication IDs, depending on the nature of the session required. Therefore, the user may interact with the PCD 14 to configure or modify the local preferences as well as interacting with the service nodes 22 to configure or modify the network preferences associated with session initiation and termination.

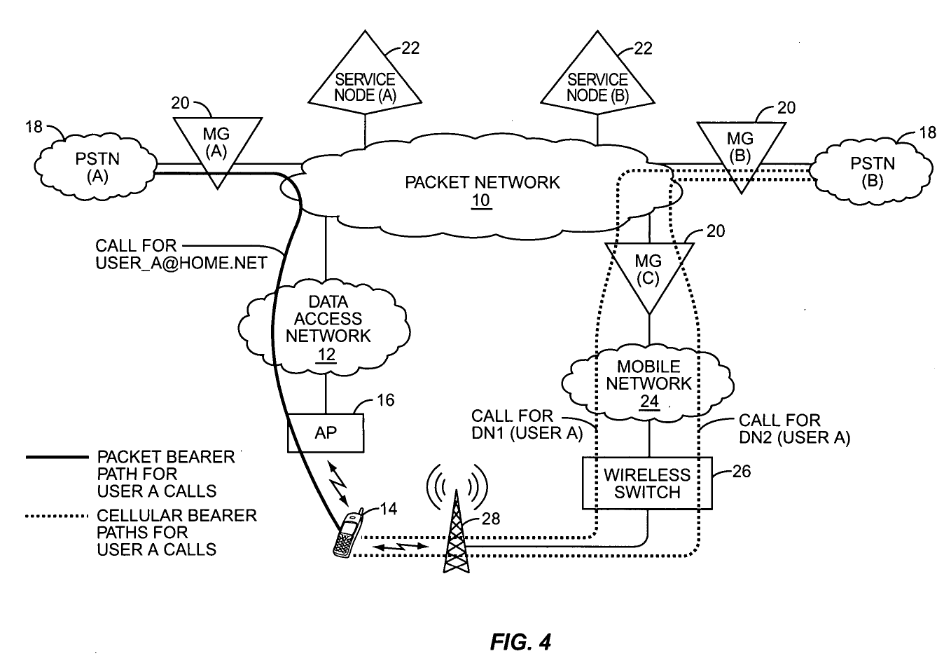

Turning now to FIG. 4, the PCD 14 may support packet-based communications and cellular communications. As such, the PCD 14 can register the packet-based communication IDs for each packet-based communication client with an appropriate service node 22, as well as register at one or more cellular communication clients with the appropriate cellular network. For cellular operation, a media gateway 20(C) may be provided to connect the packet network 10 to an appropriate mobile network 24 facilitating cellular communications. In general, the mobile network 24 will provide a wireless switch 26, which cooperates with any number of base stations 28 to facilitate cellular communications with the cellular communication interface of the PCD 14. As illustrated, the cellular communication IDs for the respective cellular communication clients are directory numbers DN1 and DN2, and bearer paths for cellular calls using the different directory numbers DN1 and DN2 are illustrated. In addition to the cellular bearer paths, a bearer path for a packet-based session with the PCD 14 is also illustrated. In this example, the PCD 14 will have multiple cellular communication clients and one or more packet communication clients, all of which are under the control of a common control system, which supports a common user interface for the user. Again, the associated communication information, such as call logs, messages, contact information, and directory information may be integrated or separated as desired by the user.

In any of the above embodiments, the PCD 14 may be configured to allow the user to select the communication client, and thus the personal communication ID, to use when initiating a session or call. Further, the PCD 14 may be configured to alert the user as to which personal communication ID is being used for incoming sessions and calls. The packet sessions may implement any type of session control and establishment protocol, such as the Session Initiation Protocol (SIP), H.323, 3GPP ICS, or other appropriate protocol. When SIP is used, the packet-based communication ID is a SIP ID, and the service nodes 22 may act as SIP proxies when establishing a session with the PCD 14. For cellular communications, one or more cellular clients may be used in association with multiple subscriber identification modules (SIMs) in traditional fashion.

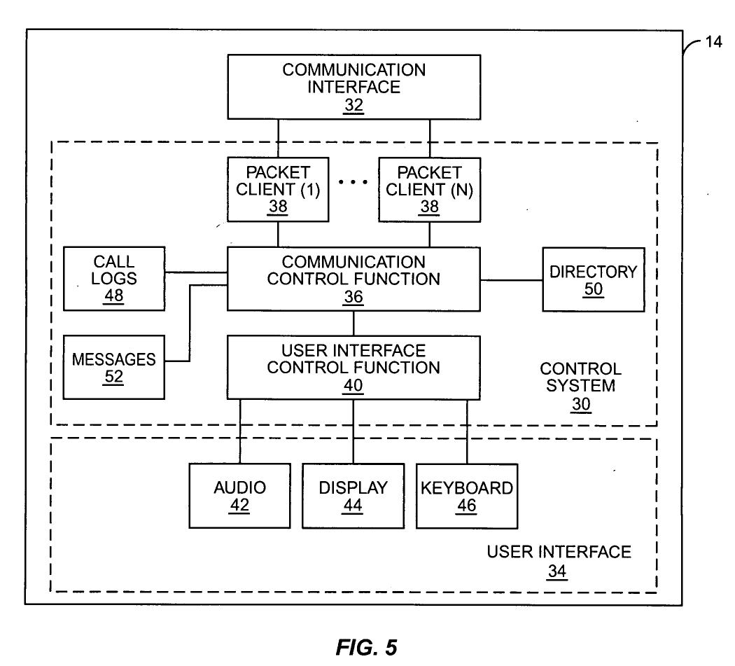

Turning now to FIG. 5, a block representation of a PCD 14 is illustrated according to one embodiment of the present invention. In this embodiment, the PCD 14 includes a control system 30 associated with a single communication interface 32 and a user interface 34. The control system 30 provides a communication control function 36, which cooperates with multiple packet communication clients 38 (1 through N), which communicate in association with a corresponding packet communication ID via the communication interface 32 using wired or wireless packet communication techniques. The control system 30 also provides a user interface control function 40, which cooperates with various components making up the user interface 34. These components may include an audio component 42, display component 44, and keyboard component 46 through which the user may carry on a conversation, see information, and enter information when using the PCD 14.

The communication control function 36 may also support one or more databases to store call logs 48, contact or directory information 50, and messages 52. Again, any of these databases may be organized to integrate or separate the information in association with the corresponding packet-based communication clients 38 and corresponding packet communication IDs. Thus, the PCD 14 can support multiple packet communication clients 38 having different packet communication IDs through a common communication interface 32 and common user interface 34.

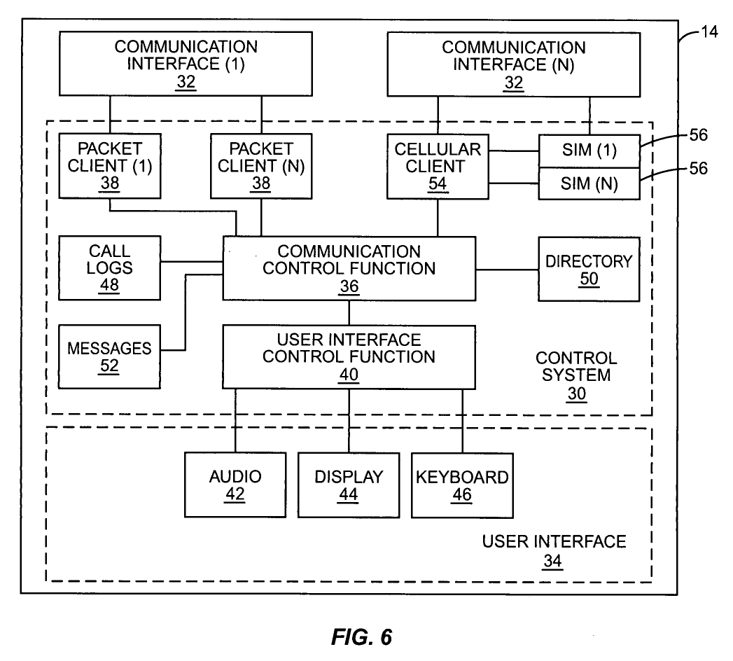

Turning now to FIG. 6, a second embodiment of a personal communication device 14 is illustrated according to the present invention. This embodiment of the PCD 14 differs from that described in association with FIG. 5 in that multiple communication interfaces 32 are provided. In the illustrated embodiment, the second communication interface 32(N) supports cellular communications, and the communication control function 36 supports a cellular client 54. The cellular client 54 may support multiple cellular IDs, such as different directory numbers, by supporting multiple subscriber identification modules 56. Each of the subscriber identification modules 56 allows the PCD 14 to appear as a unique device to the cellular network. The communication control function 36 will simply treat the cellular client or clients 54 and the different cellular IDs as additional communication clients, such as the packet communication clients 38, wherein the databases for call logs 48, messages 52, and contact or directory information 50 may be integrated or separated as desired by the user or configured by the PCD 14. Although not illustrated, the communication interfaces 32 may also support PSTN connectivity and the like.

The concepts associated with the present invention allow a single PCD 14 to support multiple communication IDs over the same or different networks. The PCD 14 will allow the user to use a common user interface 34 to readily select and use any of the communication IDs when initiating sessions or calls and control information associated with incoming or outgoing sessions or calls in an appropriate fashion. Those skilled in the art will recognize that the terms “sessions” and “calls” may be used interchangeably, and that the communication IDs may be any form of packet-based communication address, directory number, or like addressing technique for facilitating communications over wired, wireless, or cellular networks.

Those skilled in the art will recognize improvements and modifications to the preferred embodiments of the present invention. All such improvements and modifications are considered within the scope of the concepts disclosed herein and the claims that follow.

1. A personal communication device comprising:
a) at least one packet communication interface;
b) a control system associated with the at least one packet communication interface and adapted to:
i) provide a plurality of packet communication clients, which are associated with unique IDs for facilitating packet communications with the plurality of packet communication clients; and
ii) establishing packet communications with each of the plurality of packet communication clients via the at least one packet communication interface, the packet communications for each of the plurality of packet communication clients associated with a corresponding one of the IDs.

2. The personal communication device of claim 1 further comprising a user interface associated with the control system wherein the user interface and the control system are adapted to cooperate to provide a single interface for each of the plurality of communication clients.

3. The personal communication device of claim 2 wherein a user selects certain of the plurality of packet communication clients that are active at any given time.

4. The personal communication device of claim 2 wherein the control system is further adapted to combine certain communication information associated with the packet communications for each of the plurality of packet communication clients into a common database and make the communication information available to a user via the user interface.

5. The personal communication device of claim 2 wherein the control system is further adapted to store certain communication information associated with the packet communications for each of the plurality of packet communication clients in separate databases and make the communication information available to a user via the user interface.

6. The personal communication device of claim 5 wherein the control system is further adapted to combine certain of the communication information associated with the packet communications for each of the plurality of packet communication clients into a common database and make the communication information available to the user via the user interface.

7. The personal communication device of claim 1 wherein the control system is further adapted to register each of the plurality of packet communication clients with at least one service node to enable communications.

8. The personal communication device of claim 7 wherein the control system is further adapted to register certain of the plurality of packet communication clients with different service nodes.

9. The personal communication device of claim 1 wherein a first of the plurality of packet communication clients is associated with a personal communication ID and a second of the plurality of packet communication clients is associated with a business related communication ID.

10. The personal communication device of claim 1 wherein the at least one packet communication interface facilitates wireless communications.

11. The personal communication device of claim 1 wherein the at least one packet communication interface facilitates wired communications.

12. The personal communication device of claim 1 further comprising a cellular communication interface associated with the control system, the control system further adapted to provide a cellular communication client associated with at least one cellular directory number and establish cellular communications via the cellular communication interface.

13. The personal communication device of claim 1 further comprising a non-packet communication interface associated with the control system, the control system further adapted to provide at least one non-packet communication client associated with a directory number and establish non-packet communications via the non-packet communication interface.

14. The personal communication device of claim 13 further comprising a user interface associated with the control system wherein the user interface and the control system are adapted to cooperate to provide a common interface for each of the plurality of packet communication clients and the at least one non-packet communication client.

15. The personal communication device of claim 14 wherein the control system is further adapted to combine certain communication information associated with the packet and non-packet communications for each of the plurality of packet communication clients and the at least one non-packet communication client into a common database and make the communication information available to a user via the user interface.

16. The personal communication device of claim 14 wherein the control system is further adapted to store certain communication information associated with the packet and non-packet communications for each of the plurality of packet communication clients and the at least one non-packet communication client in separate databases and make the communication information available to the user via the user interface.

17. The personal communication device of claim 16 wherein the control system is further adapted to combine certain of the communication information associated with the packet and non-packet communications for each of the plurality of packet communication clients and the at least one non-packet communication client into a common database and make the communication information available to the user via the user interface.

18. The method of claim 17 wherein the communication information includes at least one of the group consisting of call logs, messages, contact information, and directory information.

19. The method of claim 1 wherein the unique IDs are Session Initiation Protocol IDs.

20. The method of claim 1 wherein different ones of the packet communication sessions are established through different access points at different locations.

21. The method of claim 1 wherein each of the plurality of packet communication clients may initiate and terminate communication sessions.

22. A method for supporting a plurality of communication clients in a personal communication device comprising:
a) providing a plurality of packet communication clients, which are associated with unique IDs for facilitating packet communications with the plurality of packet communication clients; and
b) establishing packet communications with each of the plurality of packet communication clients via at least one packet communication interface, the packet communications for each of the plurality of packet communication clients associated with a corresponding one of the IDs.

23. The method of claim 22 further comprising providing a single interface for each of the plurality of packet communication clients.

24. The method of claim 23 wherein the user can select which combination of packet communication client is active at any given time.

25. The method of claim 23 further comprising combining certain communication information associated with the packet communications for each of the plurality of packet communication clients into a common database and making the communication information available to a user via the user interface.

26. The method of claim 23 further comprising storing certain communication information associated with the packet communications for each of the plurality of packet communication clients in separate databases and make the communication information available to a user via the user interface.

27. The method of claim 26 further comprising combining certain of the communication information associated with the packet communications for each of the plurality of packet communication clients into a common database and making the communication information available to the user via the user interface.

28. The method of claim 22 further comprising registering each of the plurality of packet communication clients with at least one service node to enable communications.

29. The method of claim 28 further comprising registering certain of the plurality of packet communication clients with different service nodes.

30. The method of claim 22 wherein a first of the plurality of packet communication clients is associated with a personal communication ID and a second of the plurality of packet communication clients is associated with a business related communication ID.

31. The method of claim 22 further comprising providing at least one communication interface to facilitate wireless communications.

32. The method of claim 22 further comprising providing at least one communication interface to facilitate wired communications.

33. The method of claim 22 further comprising providing a cellular communication client associated with at least one cellular directory number and establishing cellular communications with the cellular communication client.

34. The method of claim 22 further comprising providing at least one non-packet communication client associated with a directory number and establishing non-packet communications with the at least one non-packet communication client.

35. The method of claim 34 further comprising providing a common interface for each of the plurality of packet communication clients and the at least one non-packet communication client.

36. The method of claim 35 further comprising combining certain communication information associated with the packet and non-packet communications for each of the plurality of packet communication clients and the at least one non-packet communication client into a common database and making the communication information available to a user via the user interface.

37. The method of claim 35 further comprising storing certain communication information associated with the packet and non-packet communications for each of the plurality of packet communication clients and the at least one non-packet communication client in separate databases and making the communication information available to a user via the user interface.

38. The method of claim 37 further comprising combining certain of the communication information associated with the packet and non-packet communications for each of the plurality of packet communication clients and the at least one non-packet communication client into a common database and making the communication information available to the user via the user interface.

39. The method of claim 38 wherein the communication information includes at least one of the group consisting of call logs, messages, contact information, and directory information.

40. The method of claim 22 wherein the unique IDs are Session Initiation Protocol IDs.

41. The system of claim 22 wherein different ones of the packet communication sessions are established through different access points at different locations.

42. The system of claim 22 wherein each of the plurality of packet communication clients may initiate and terminate communication sessions.
